(19) United States
(12) Patent Application Publication
(10) Pub. No.: US 2011/0285758 A1
(43) Pub. Date: Nov. 24, 2011

(54) IMAGE DISPLAY APPARATUS

(75) Inventor: Katsuhiko Matsushita, Hirakata City (JP)

(73) Assignee: SANYO ELECTRIC CO., LTD., Moriguchi City (JP)

(21) Appl. No.: 13/112,259

(22) Filed: May 20, 2011

(30) Foreign Application Priority Data
May 20, 2010 (JP) 2010-115912

(51) Int. Cl. G09G 5/10; G09G 3/36

(52) U.S. Cl. 345/690; 345/87

(57) ABSTRACT

An image display apparatus that displays an image with adjustments made in the luminance of the individual pixels of a display includes: a weighting portion which assigns weights to the luminance of the individual pixels according to their position on the display. The weights assigned as a result of the weighting are set so as to decrease from the center to the edge of the display.

This application is based on Japanese Patent Application No. 2010-115912 filed on May 20, 2010, the contents of which are hereby incorporated by reference.

### BACKGROUND OF THE INVENTION

1. Field of the Invention

The present invention relates to an image display apparatus that displays an image with adjustments made in the luminance of the individual pixels of a display.

2. Description of Related Art

Today, environmental issues tend to receive much attention, and electric appliances of every kind are expected to be designed to consume less electric power. The circumstances apply to image display apparatuses of every kind such as television receivers.

In general, an image display apparatus emits light by use of the electric power supplied to it, and displays an image by use of the light so emitted. For example, in the case of a plasma display apparatus, such light emission takes place in each pixel. The duration of light emission is adjusted pixel by pixel so that, the longer the duration of light emission at a pixel is, the higher the apparent luminance of the pixel is. The duration of light emission at different pixels is adjusted so that they as a whole display an image. A higher luminance image is displayed by a longer light emission duration at each pixel, and thus increases electric power for light emission.

In the case of a liquid crystal display apparatus, by use of the electric power supplied to it, a backlight is lit, and the degree of transmission of the backlight through each pixel is adjusted to display an image. Thus, the brighter the backlight is, the higher the luminance of image can be displayed. This also increases electric power. In this way, making the image displayed on an image display apparatus brighter requires accordingly increased electric power for light emission.

As described above, in an image display apparatus, the electric power consumption increases to make the higher luminance of image. Thus, from the viewpoint of minimizing electric power consumption, it is desirable to hold display luminance as low as possible. For example, it is desirable to keep display brightness as low as possible by, in the case of a plasma display apparatus, reducing the light emission duration at each pixel and, in the case of a liquid crystal display apparatus, reducing the brightness of the backlight.

On the other hand, when displaying an image, it is as important to take care not to make the viewer perceive the image to be dim. Thus, even when a reduction in electric power consumption is attempted by holding display luminance low, it is desirable not to make the viewer perceive the image to be dim.

### SUMMARY OF THE INVENTION

According to the present invention, an image display apparatus that displays an image with adjustments made in the luminance of the individual pixels of a display includes a weighting portion which assigns weights to the luminance of the individual pixels according to their position on the display. Here, the weights assigned as a result of the weighting are set so as to decrease from the center to the edge of the display.

### BRIEF DESCRIPTION OF THE DRAWINGS

The objects and features of the present invention will become apparent from the following description of preferred embodiments taken in conjunction with the accompanying drawings, in which:

FIG. 1 is a diagram showing the configuration of an image display apparatus according to a first embodiment;

FIG. 2 is a graph showing one example of a weighting pattern;

FIG. 3 is a diagram illustrating the weighting pattern;

FIG. 4 is a diagram illustrating unweighted image data;

FIG. 5 is a diagram illustrating weighted image data;

FIG. 6 is a graph showing another example of a weighting pattern;

FIG. 7 is a graph showing yet another example of a weighting pattern;

FIG. 8 is a diagram showing the configuration of an image display apparatus according to a second embodiment; and

FIG. 9 is a diagram showing the configuration of a liquid crystal panel and an area-driven backlight.

### DETAILED DESCRIPTION OF PREFERRED EMBODIMENTS

Hereinafter, the present invention will be described in detail by way of embodiments, namely a first and a second embodiment.

### 1. First Embodiment

First, as one embodiment of the invention, a first embodiment will be described below.

Configuration etc. of an Image Display Apparatus: FIG. 1 is a diagram showing the configuration of an image display apparatus 1 according to the invention. As shown there, the image display apparatus 1 includes a group of terminals 11, a selector 12, an image data processing circuit 13, a weighting circuit 14, a PDP (plasma display panel) driver 15, a PDP 16, a control portion 17, an operated portion 18, etc.

The group of terminals 11 includes some terminals for receiving image data from outside. Image data denotes data containing luminance values of a plurality of pixels constituting an image, and hence data that identifies a particular image (a still image, or a frame from a moving image). Luminance values are values representing the luminance of pixels, and are given as, for example, ratios with respect to a reference level of luminance.

The group of terminals 11 may include varying types of terminal, examples including an antenna terminal which is connected to an antenna to receive television broadcast signals, a PC terminal which is connected to a personal computer, and an HDMI terminal complying with the HDMI standard. In a case where an antenna terminal is provided, it is preferable to provide, at the succeeding stage, a tuner for selecting the desired channel.

The selector 12 is connected, on the preceding stage side, to the terminals in the group of terminals 11 and, on the succeeding stage side, to the image data processing circuit 13. The selector 12 connects one of the terminals to the image data processing circuit 13. Which terminal to connect is switched according to an instruction from the control portion 17. This permits one of the terminals to be selected as valid, so that the image data received at that terminal is delivered to the image data processing circuit 13.

The image data processing circuit 13 applies various kinds of processing to the image data received from the preceding stage, and delivers the image data that has undergone the processing to the succeeding stage. The processing that the image data processing circuit 13 performs may be of any of a variety of kinds.

For example, the image data processing circuit 13 may be configured to perform all or some of the following kinds of processing: A/D (analog-to-digital) conversion, decoding, IP conversion, frame rate conversion, format conversion, and image quality adjustment. The image data that has undergone the processing performed by the image data processing circuit 13 is data containing luminance values corresponding to the individual pixels of the PDP 16.

The weighting circuit 14 performs weighting on the individual luminance values of the image data received from the image data processing circuit 13. How the weighting is performed will be discussed in detail later. The image data that has undergone the weighting is output to the PDP driver 15. In the following description, for convenience' sake, the image data immediately before undergoing the weighting is occasionally referred to as the “unweighted image data,” and the image data having undergone the weighting is occasionally referred to as the “weighted image data.”

The PDP driver 15 controls the PDP 16 based on the weighted image data. That is, the PDP driver 15 controls the PDP 16 so that the individual pixels of the PDP 16 emit light at luminance levels that correspond to the weighted image data.

The PDP 16 is configured as a common PDP having, for example, 1920×1080 dots of color pixels (R (red), G (green), and B (blue) pixels) for full HDTV (high-definition television). The number and kinds of the pixels may be other than specifically mentioned here.

In the PDP 16, discharge cells filled with a gas that produces plasma are provided one for each pixel. When a discharge cell is supplied with electric power, electric discharge occurs and produces plasma, which causes the pixel corresponding to the discharge cell to emit light. In this way, the PDP 16 emits light by use of electric power pixel by pixel.

The apparent luminance of a pixel is commensurate with the light emission duration of the pixel. Accordingly, to increase the luminance of a pixel, it is necessary to accordingly increase the electric power (as averaged for each frame) that is supplied to the discharge cell of the pixel. Conversely, by reducing the brightness of a pixel, it is possible to accordingly reduce the electric power that is supplied to the discharge cell of the pixel (this electric power can be regarded as part of the electric power consumed by the image display apparatus 1).

The control portion 17 includes, for example, a CPU (central processing unit), and controls different parts of the image display apparatus 1 to make it operate properly. The operated portion 18 includes, for example, a remote control device and key-switches. As the operated portion 18 is operated by the viewer, it outputs information on how it is operated to the control portion 17. This permits the control portion 17 to control the relevant parts in a way reflecting the viewer's intention.

The image display apparatus 1 is configured as described above; that is, it applies various kinds of processing to the image data it receives from outside, and by use of the resulting image data, displays an image on the screen (hereinafter also referred to simply as the “display”) of the PDP 16.

How the Weighting is Achieved: As described above, the weighting circuit 14 performs weighting on the individual luminance values of unweighted image data to produce weighted image data. The weighting here is performed based on a weighting pattern that is stored in the weighting circuit 14 beforehand.

The weighting pattern is a group of information that contains weighting coefficients (coefficients each representing a weight) set for the individual pixels on the display. Since the positions of the individual pixels on the display are fixed, the weighting coefficients can be seen as being set for different positions on the display. The weighting is achieved by multiplying the luminance values of the individual pixels contained in the unweighted image data by the weighting coefficients corresponding to the pixels.

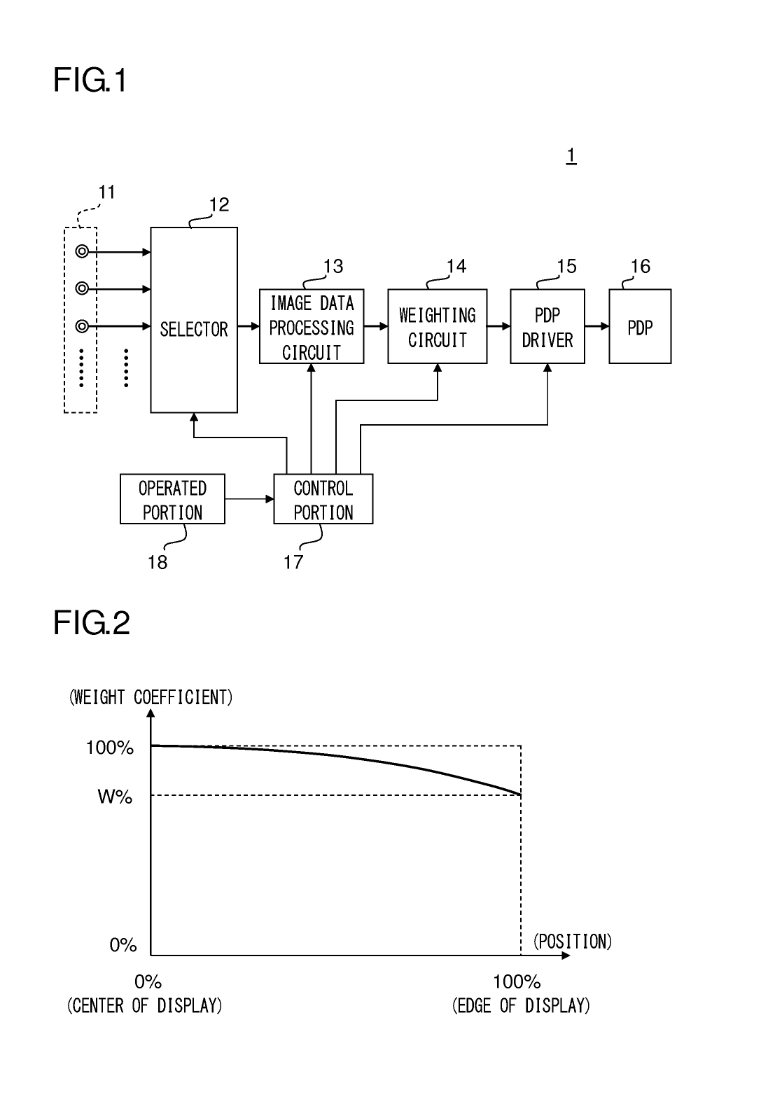

The weighting pattern is so set that the weighting coefficients decrease from the center to the edge of the image. More specifically, the weighting coefficients are so set as to vary as shown in a graph in FIG. 2.

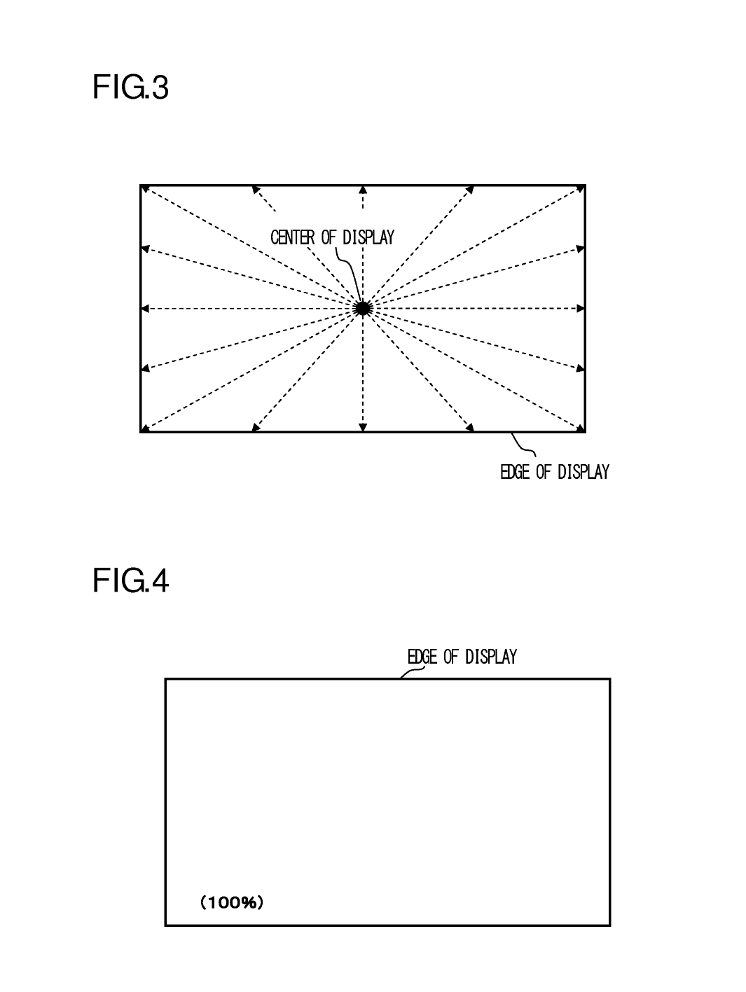

In FIG. 2, taken along the horizontal axis is, as an indicator representing a position from center to edge across the screen in any direction (through 360 degrees, as indicated by arrows in FIG. 3), the value calculated by dividing the distance from the center of the display to that position by the distance from the center to the edge of the display. Taken along the vertical axis is the weighting coefficient.

According to FIG. 2, at the center of the image, the weighting coefficient is 100%; at the edge of the image, the weighting coefficient is W % smaller than 100% (in the following description, assumed to be 80%). Performing weighting on luminance values with this weighting pattern results in their being adjusted such that the luminance is reduced at higher weights the closer to the edge of the image.

FIG. 4 shows the luminance in the unweighted image data, and FIG. 5 shows the luminance in the weighted image data. The values indicated in these figures are ratios with respect to the luminance in the unweighted image data taken as a reference level of luminance.

As shown in FIG. 5, in the weighted image data, an area A1 which occupies a predetermined region at the center of the image is where the luminance has remained almost unchanged (retained at 95% or more) as compared with in the unweighted image data. An area A2 around area A1 is where the luminance has been adjusted to be slightly lower than in area A1. An area A3 around area A2 is where the luminance has been adjusted to be slightly lower than in area A2. An area A4 around area A3 is where the luminance has been adjusted to be slightly lower than in area A3.

Effect of the Weighting: As will be clear from FIG. 5 etc., the average value of the luminance represented by the weighted image data is smaller than that represented by the unweighted image data. Accordingly, displaying an image on the display based on weighted image data requires less electric power for display than displaying an image on the display based on unweighted image data.

Thus, performing the weighting described above can reduce the electric power consumption by the image display apparatus 1. Compared with displaying with the pattern shown in FIG. 4, displaying with the pattern shown in FIG. 5 is expected to achieve an about 10% reduction in electric power consumption.

Apparently, it is feasible to reduce the electric power consumption by the image display apparatus 1 by, instead of performing the weighting described above, reducing the luminance of all the pixels uniformly, for instance. However, doing so makes it more likely that the viewer perceives the image to be dimmer due to reduced luminance. Thus, taking care not to make the viewer feel unnatural hampers achieving a satisfactory reduction in luminance and hence a satisfactory cut in electric power consumption.

As a solution, in this embodiment, weighting is performed according to the position on the display, and this makes it possible to minimize the likelihood of the viewer perceiving the image to be dim due to reduced luminance. Specifically, when an image is displayed on the display, the viewer usually tries to put the entire image inside the field of view. As a result, the viewer's viewpoint concentrates in a part of the display close to its center, and thus a part of the display close to its edge is left away from the viewer's viewpoint.

Accordingly, in a case where an image is displayed with the pattern shown in FIG. 5, the viewer is comparatively sensitive to the luminance in a part of the display close to its center, like the first are A1, but is comparatively insensitive to the luminance in a part of the display close to its edge, like the fourth are A4. As a result, even when an image is displayed with the pattern shown in FIG. 5, the viewer perceives it to be fairly comparable in luminance with that displayed with the pattern shown in FIG. 5.

As described above, in this embodiment, it is possible, while taking care not to make the viewer perceive an image to be dim, to minimize the luminance of the individual pixels of the PDP 16.

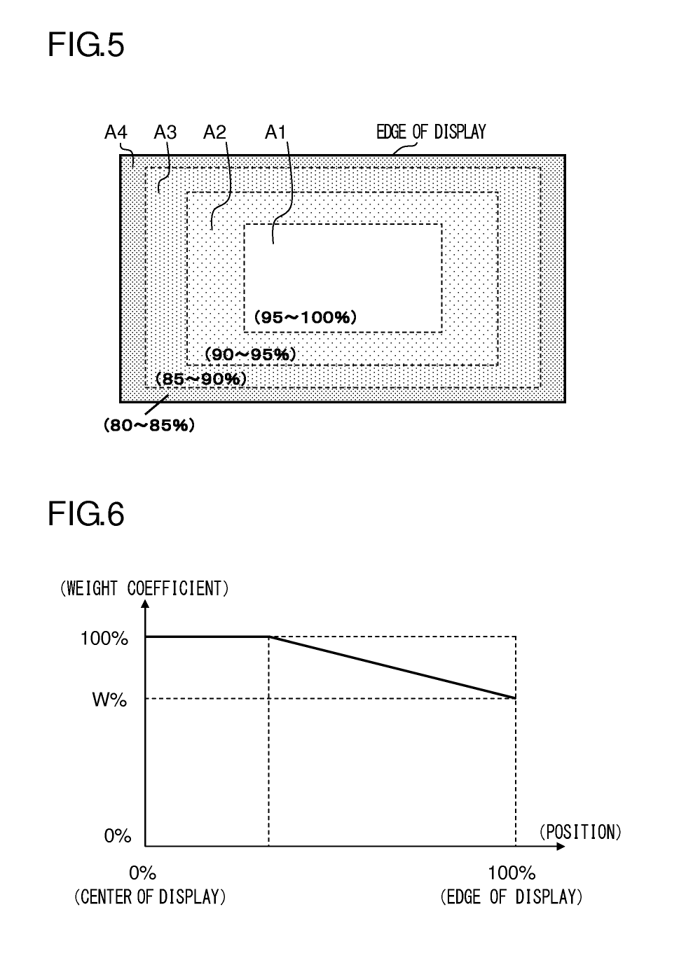

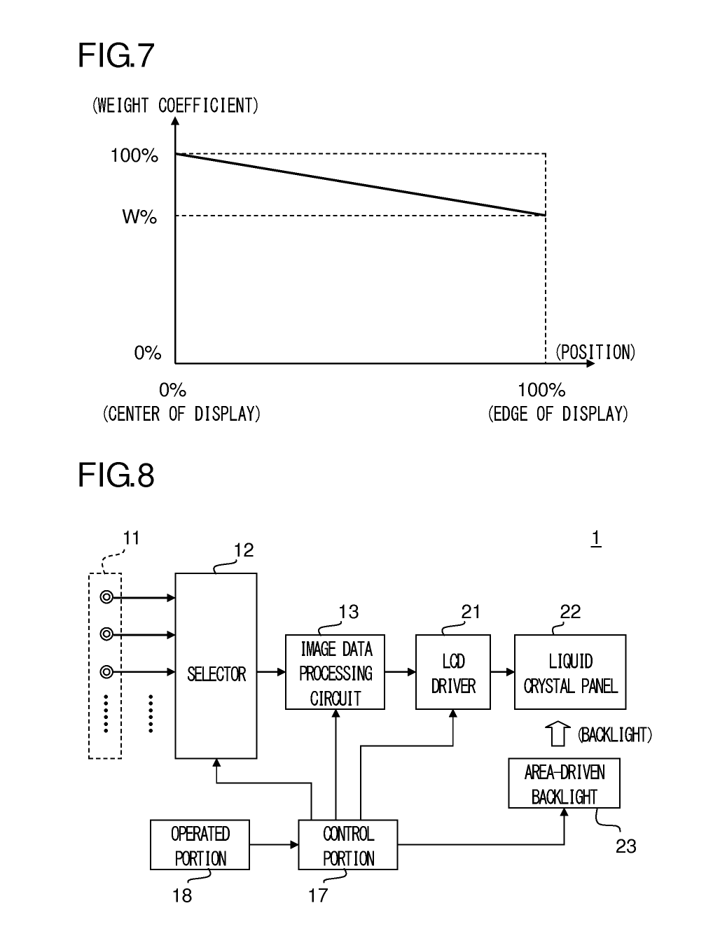

Specific Weighting Patterns: The weighting pattern is not limited to the one shown in FIG. 2. It is possible to adopt a weighting pattern as shown in FIG. 6, or a weighting pattern as shown in FIG. 7.

The weighting pattern shown in FIG. 2 is so set that the weighting coefficient describes a parabola from the center to the edge of the display. In other words, the rate of change of the weighting coefficient is so set as to increase gradually from the center to the edge of the display. Accordingly, with this weighting pattern, the luminance of the image displayed on the display varies smoothly from center to edge, and thus it is possible to minimize the unnaturalness felt by the viewer.

With the weighting pattern shown in FIG. 6, inside a predetermined area at the center of the display, the weighting coefficient is fixed at 100%, and outside the predetermined region, the weighting coefficient decreases gradually toward the edge of the display. When this weighting pattern is adopted, as compared with when the weighting pattern shown in FIG. 2 is adopted, the reduction in electric power consumption tends to be smaller, but the viewer is less likely to perceive the image to be dim.

On the other hand, with the weighting pattern shown in FIG. 7, from the center to the edge of the display, the weighting coefficient decreases at a constant rate of change. When this weighting pattern is adopted, as compared with when the weighting pattern shown in FIG. 2 is adopted, the viewer is more likely to perceive the image to be dim, but it is easier to achieve a greater reduction in electric power consumption.

In the image display apparatus 1, a plurality of weighting patterns may be registered beforehand. Which of the weighting patterns to actually apply may then be determined according to an instruction from the viewer as desired.

The weighting pattern may be configured to allow updating according to an instruction from the viewer. This makes it possible to adapt how the image is displayed to the viewer's preferences.

In a case where the luminance level in the unweighted image data is higher than a predetermined level, even when the weighting is performed, no effect of reducing electric power consumption may be obtained. Even in that case, performing the weighting makes the luminance in a part of the display close to its center (the part in which the viewer's viewpoint concentrates) relatively high. This makes the viewer perceive as if the overall luminance has increased.

### 2. Second Embodiment

Next, another embodiment (a second embodiment) of the invention will be described. The following description focuses on differences from the first embodiment, and no description common to the first embodiment will be repeated unless necessary.

FIG. 8 is a diagram showing the configuration of an image display apparatus according to this embodiment. As shown there, the image display apparatus 1 includes a group of terminals 11, a selector 12, an image data processing circuit 13, a control portion 17, an operated portion 18, an LCD (liquid crystal display) driver 21, a liquid crystal panel 22, an area-driven backlight 23, etc. The group of terminals 11, the selector 12, the image data processing circuit 13, the control portion 17, and the operated portion 18 are configured in similar manners to those in the first embodiment (except for how the control portion 17 operates).

The LCD driver 21 controls the liquid crystal panel 22 based on image data (data containing luminance values corresponding to the individual pixels of the liquid crystal panel 22) received from the image data processing circuit 13. That is, the LCD driver 21 controls the degree of transmission of light (backlight) through the individual pixels of the liquid crystal panel 22 according to the image data.

The liquid crystal panel 22 is configured as a common liquid crystal panel having, for example, 1920×1080 dots of color pixels (R, G, and B pixels) for HDTV. The number and kinds of the pixels may be other than specifically mentioned here. As is well known, a liquid crystal panel does not emit light itself, but displays an image through adjustment of the degree of transmission of light.

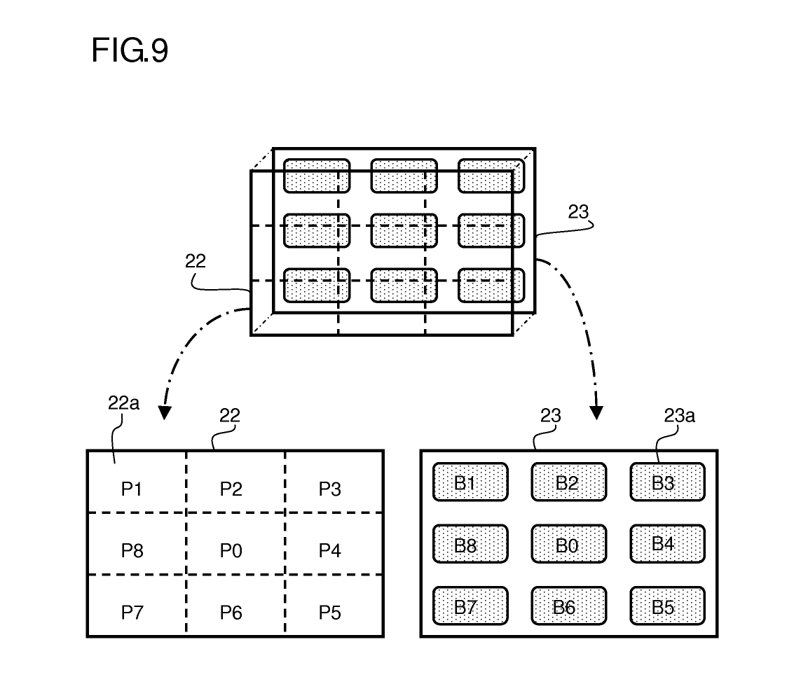

The area-driven backlight 23 is arranged behind the liquid crystal panel 22, and emits backlight. The backlight is shone to the liquid crystal panel 22 continuously as long as it displays an image. The area-driven backlight 23 permits the brightness of the backlight separately for each of a plurality of areas into which the liquid crystal panel 22 is divided. This will now be described in more detail with reference to FIG. 9.

FIG. 9 is a diagram schematically showing the configuration of the liquid crystal panel 22 and the area-driven backlight 23. As shown there, the area-driven backlight 23 has the shape of a flat plate as a whole, and is arranged to face the liquid crystal panel 22. On the surface of the flat plate, a plurality of light-emitting devices 23a (here, nine of them, B0 to B8) are arranged at approximately equal intervals.

The light-emitting devices 23a each include, for example, an LED (light-emitting diode) unit composed of R, G, and B LEDs (configured so as to emit white light as a whole) and a light guide plate. The light-emitting devices 23a can each emit light at a brightness level independent of the brightness levels of the others, and their respective brightness levels are controlled by the control portion 17.

When the liquid crystal panel 22 is considered to be divided into nine areas 22a, identified as P0 to P8 respectively, as shown in FIG. 9, each light-emitting device 23a is arranged substantially right behind one of the areas 22a. More specifically, the light-emitting device 23a identified as Bn (where n is 0 to 8) is arranged substantially right behind the area 22a identified as Pn. Thus, the brighter the light emitting device 23a of Bn is, the higher the luminance of the image is displayed mainly in the area 22a identified as Pn. Thus, the light-emitting device 23a identified as Bn is provided so as to correspond to the area 22a identified as Pn so that the brightness of the backlight can be set independently for each area 22a.

In controlling the brightness of the light-emitting devices 23a, the control portion 17 assigns a predetermined brightness value α1 to the light-emitting device23a identified as B0 which corresponds to the area identified as P0 (the area located at the center of the liquid crystal panel 22). On the other hand, it assigns a predetermined brightness value α2 smaller than α1 (for example, about 90% of α1) to the light-emitting devices 23a identified as B1 to B8 corresponding to the other areas (the areas located outside P0).

As a result, less electric power is required for image display than when the brightness of all the light-emitting devices 23a is set at α1. Thus, it can be said that weighting the brightness of the individual light-emitting devices 23a contributes to a reduction in the electric power consumption by the image display apparatus 1.

In this embodiment, instead of lowering the brightness of all the light-emitting devices 23a uniformly, the brightness in a part of the display closer to its edge is made lower than in a part of the display close to its center. Thus, as in the first embodiment, it is possible, while taking care not to make the viewer perceive an image to be dim, to minimize the luminance of the area-driven backlight 23 (light source).

As described above, in the image display apparatus 1 according to this embodiment, processing that brings about a similar effect to the weighting in the first embodiment is achieved by varying the brightness among the light-emitting devices 23a. The number, arrangement, etc. of the light-emitting devices 23a may be other than described above, and many variations and modifications are possible.

### 3. Supplementary Notes

As described above, an image display apparatuses 1 embodying the invention displays an image with adjustments made in the luminance of the individual pixels of a display. And the image display apparatus 1 includes a functional section (weighting portion) that assigns weights to the luminance of the individual pixels according to their position on the display. The weights assigned as a result of the weighting are so set as to decrease from the center to the edge of the display.

The viewer watching the image displayed on the display is usually comparatively sensitive to the luminance in a part of the display close to its center but comparatively insensitive to the luminance in a part of the display close to its edge. Accordingly, with the image display apparatus 1, it is possible, while taking care not to make the viewer perceive the image to be dim, to minimize the average brightness of display, and thereby to minimize electric power consumption.

The expression “decrease from center to edge” does not simply denote patterns in which a value decreases monotonously from center to edge but encompasses patterns in which a value remains constant within part of the whole range like the one shown in FIG. 6. The weighting may be performed not only through multiplication by weighting coefficients as in the embodiments but by any of various methods.

The image display apparatus 1 according to the first embodiment adopts as a display a plasma display (of the type that emits light by using electric power separately for each pixel), and stores weighting coefficients that are set pixel by pixel such as to decrease from the center to the edge of the display. Moreover, the weighting circuit 14 receives unweighted image data (image data representing the luminance values of the individual pixels), and by multiplying the luminance values by the weighting coefficients, produces weighted image data (corrects the unweighted image data).

The image display apparatus 1 according to the second embodiment adopts as a display a liquid crystal panel 22, and is provided with light-emitting devices 23a emitting backlight which are provided separately to correspond to areas 22a into which the liquid crystal panel is divided. The image display apparatus 1 performs weighting by varying brightness among the light-emitting devices 23a.

It should be understood that the embodiments by way of which the invention has been described are not meant to limit the invention in any way. The invention may be carried out with many variations and modifications made without departing from the spirit of the invention. With an image display apparatus according to the invention, it is possible, while taking care not to make the viewer perceive an image to be dim, to minimize the average luminance of display.

What is claimed is:

1. An image display apparatus that displays an image with adjustments made in luminance of individual pixels of a display, the apparatus comprising:
a weighting portion which assigns weights to the luminance of the individual pixels according to position thereof on the display, wherein
the weights assigned as a result of the weighting are set so as to decrease from a center to an edge of the display.

2. The apparatus according to claim 1, wherein
the display is of a type that emits light by using electric power pixel by pixel,
the weighting portion
stores weighting coefficients set for the pixels respectively such as to decrease from the center to the edge of the display, and
receives image data representing luminance values of the individual pixels and, by multiplying the luminance values by the weighting coefficients, corrects the image data.

3. The apparatus according to claim 2, wherein
the weighting coefficients are set such that a rate of change thereof gradually increases from the center to the edge of the display.

4. The apparatus according to claim 2, wherein
the display is a plasma display.

5. The apparatus according to claim 3, wherein
the display is a plasma display.

6. The apparatus according to claim 2, wherein
a plurality of candidates for a weighting pattern which determines the weighting coefficients for the individual pixels are registered, and
which of the candidates to use is determined according to an instruction from a viewer.

7. The apparatus according to claim 3, wherein
a plurality of candidates for a weighting pattern which determines the weighting coefficients for the individual pixels are registered, and
which of the candidates to use is determined according to an instruction from a viewer.

8. The apparatus according to claim 4, wherein
a plurality of candidates for a weighting pattern which determines the weighting coefficients for the individual pixels are registered, and
which of the candidates to use is determined according to an instruction from a viewer.

9. The apparatus according to claim 5, wherein
a plurality of candidates for a weighting pattern which determines the weighting coefficients for the individual pixels are registered, and
which of the candidates to use is determined according to an instruction from a viewer.

10. The apparatus according to claim 1, wherein
the display comprises a liquid crystal panel and light-emitting devices provided separately one for each of areas into which the liquid crystal panel is divided, and
the weighting portion performs the weighting by varying brightness among the light-emitting devices.
